(19) United States
(12) Patent Application Publication
(10) Pub. No.: US 2009/0010022 A1
(43) Pub. Date: Jan. 8, 2009

(54) MULTI-FUNCTIONAL LED LAMP

(76) Inventor: Tzung-Shiun TSAI, Kaohsiung City (TW)

Correspondence Address: SINORICA, LLC, 528 FALLSGROVE DRIVE, ROCKVILLE, MD, 20850, US

(21) Appl. No.: 11/773,125

(22) Filed: Jul. 3, 2007

(51) Int. Cl. F21S 6/00; F21V 7/04

(52) U.S. Cl. 362/606; 362/257; 362/621

(57) ABSTRACT

A multi-functional LED lamp is mainly composed of a lamp base, an illuminant device, a light guide device and a lampshade. The illuminant device is provided with plural LED bulbs planted on a laminate that is fixed on the lamp base with a heat-conductive medium spread in between. Heat generated by the illuminant device is dispersed by the lamp base. The light guide device is transparent, placed at a place where the illuminant device is to emit, used to conduct the light beams and promote its brightness. The lampshade is covered on the light guide device and the illuminant device. With features of low energy consumption, long service life and high luminous efficiency for LEDs and a good cooling member, the LED lamp is really energy saving and high-efficient.

### BACKGROUND OF THE INVENTION

1. Field of the Invention

This invention relates to a multi-functional LED lamp, particularly to one provided with a lamp base with an excellent heat-conductive property, able to save energy and promote its brightness.

2. Description of the Prior Art

As we know, conventional lights, a tube or a bulb, have still a lot of disadvantages that need to be improved. First, they cannot achieve an illuminant efficiency as high as 100%, wasting too much energy to cause a financial burden. Second, they cannot serve for a long time, posing a high cost for maintenance or being often replaced with a new one. Third, heavy metals, such as mercury or lead, are added in the conventional lights while manufacturing, possible to cause ecological contamination.

### SUMMARY OF THE INVENTION

The objective of this invention is to offer a multi-functional LED lamp.

The main characteristics of the invention are a lamp base, an illuminant device, a light guide device and a lampshade. The lamp base is integrally made of good heat-conductive material, provided with a cooling member formed on its outer surface for massively dispersing heat, and a chamber formed inside it. The illuminant device is provided with plural LEDs planted on a circumference of a laminate (an ALPCB or a PCB) by tin welding, which is positioned at a proper location in the chamber of the lamp base with a heat-conductive medium spread in between. The light guide device is transparent, positioned at a place where the illuminant device is to emit. The lampshade is shaped to match with the lamp base, for covering on the light guide device and the illuminant device and positioned on the lamp base.

Therefore, with the light guide device, the light of the LEDs is transmitted to promote its brightness; with the heat-conductive medium, the heat generated by the LED can be conducted to the lamp base and dispersed to atmosphere, providing a good cooling way. And, combined with advantages of low energy consumption, long service life and high illuminant efficiency of the LEDs, the present invention can really save energy and advance its brightness.

### BRIEF DESCRIPTION OF DRAWINGS

This invention is better understood by referring to the accompanying drawings, wherein:

FIG. 1 is an exploded perspective view of a first preferred embodiment of a multi-functional LED lamp in the present invention;

FIG. 2 is a rear view of a lamp base of the first preferred embodiment of a multi-functional LED lamp in the present invention;

FIG. 3 is a partial top view of the first preferred embodiment of a multi-functional LED lamp in the present invention, showing a first arrangement for a plurality of the embodiments assembled together horizontally;

FIG. 4 is a top view of the first preferred embodiment of a multi-functional LED lamp in the present invention, showing a second arrangement for a plurality of the embodiments assembled together vertically;

FIG. 5 is a front view of the first preferred embodiment of a multi-functional LED lamp in the present invention, showing a plurality of the embodiments assembled together vertically;

FIG. 6 is a top view of the first preferred embodiment of a multi-functional LED lamp in the present invention, showing plural illuminant devices being installed;

FIG. 7 is a side view of the first preferred embodiment of a multi-functional LED lamp in the present invention, showing plural lamp bases being installed by superposing;

FIG. 8 is an exploded perspective view of a second preferred embodiment of a multi-functional LED lamp in the present invention;

FIG. 9 is an exploded perspective view of a third preferred embodiment of a multi-functional LED lamp in the present invention, showing a first way of combination;

FIG. 10 is an exploded perspective view of a third preferred embodiment of a multi-functional LED lamp in the present invention, showing a second way of combination; and

FIG. 11 is an exploded perspective view of a third preferred embodiment of a multi-functional LED lamp in the present invention, showing a third way of combination.

### DETAILED DESCRIPTION OF THE PREFERRED EMBODIMENT

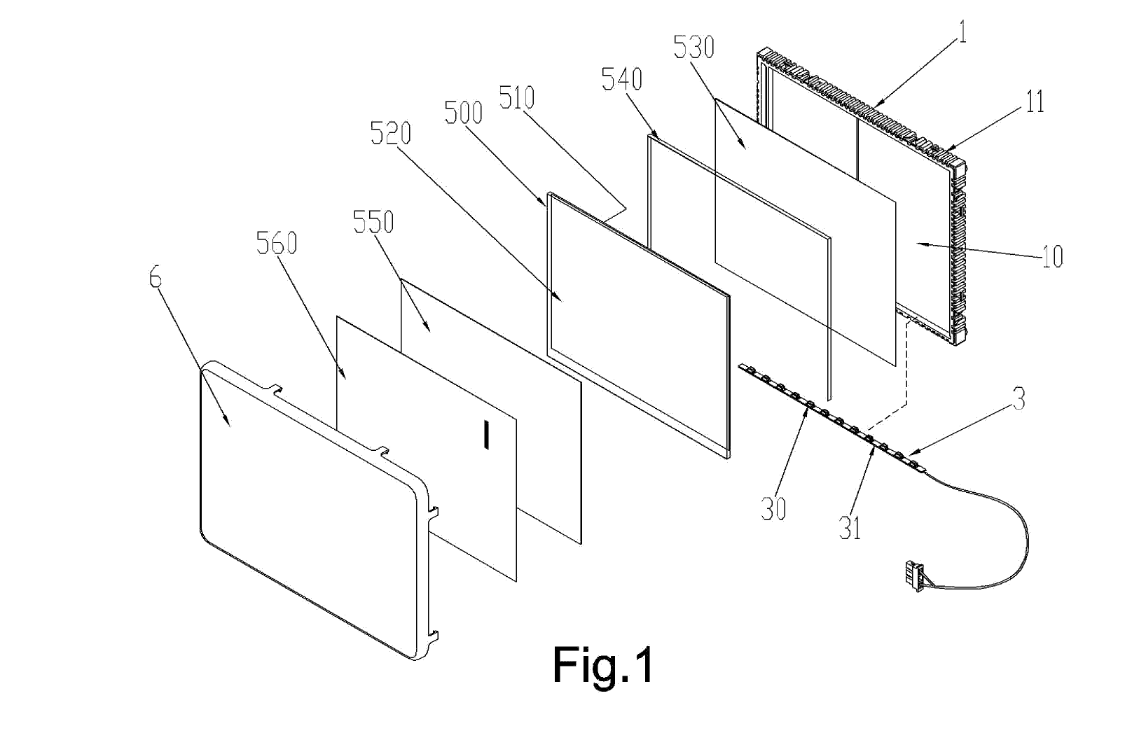

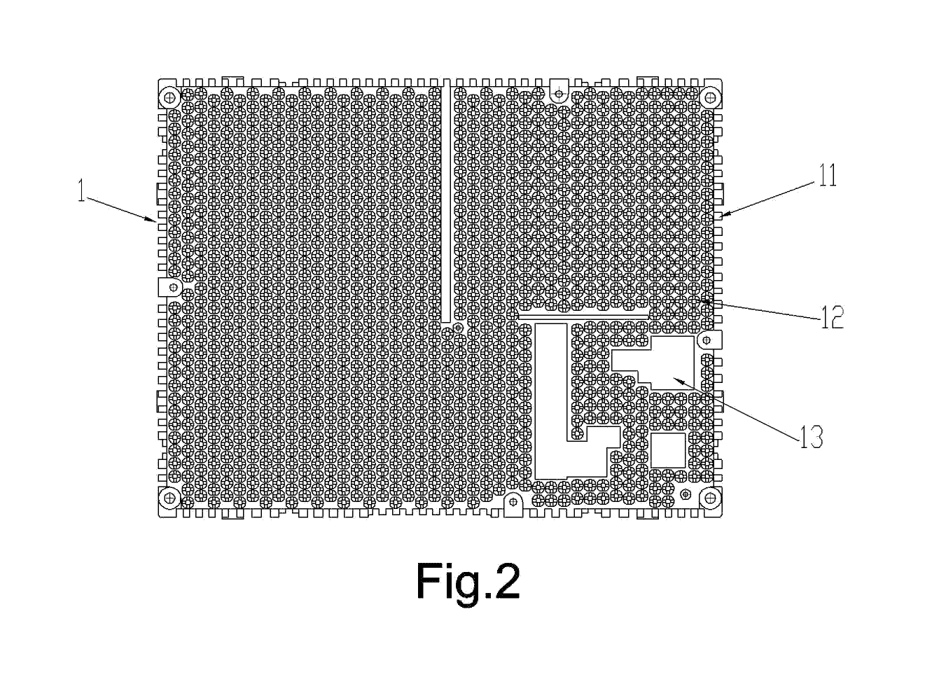

As shown in FIGS. 1 and 2, a first preferred embodiment of a multi-functional LED lamp in the present invention is mainly composed of a lamp base 1, an illuminant device 3, a light guide plate 500, a reflector 510, a diffusion sheet 520 and a lampshade 6.

The lamp base 1 is made of aluminum, aluminum alloy, copper, copper alloy, gold, gold alloy, plastics, woods, ceramic, carton, graphite, carbon fiber, heat-resistant glass, glass fiber, Teflon, or Teflon added with metals (such as graphite, aluminum, gold, copper etc.) to form Teflon graphite, Teflon aluminum, Teflon copper with a property of good thermal conductivity, manufactured by injection, casting or extrusion and generally shaped planar. The lamp base 1 is provided with a plurality of fins 11 and cooling particles 12 formed integrally or made into independent components and then, assembled around its outer surface and on its rear side, employed to massively disperse heat. The lamp base 1 is also provided with a chamber 10 formed inside it, and a groove 13 formed in its rear side for containing a printed circuit board with an IC chip and passive components (such as a rectification circuit chip).

The illuminant device 3 is provided with a laminate 31 that is planted with plural LEDs 30 with a diversity of low/medium/high power by means of tin welding. The laminate 31 can be a printed circuit board (PCB) or an aluminum PCB (ALPCB), properly positioned in the chamber 10 of the lamp base 1 via coating with a heat-conductive medium, such as a heat-conductive paste, a heat-conductive silicon rubber, a heat-conductive tape or a heat-conductive spacer. Like the lamp base 1, the laminate 31 is also made of aluminum, aluminum alloy, copper, copper alloy, gold, gold alloy, carton, graphite, carbon fiber, heat-resistant glass, glass fiber, ceramic, Teflon, Teflon graphite, or Teflon aluminum. Or, the laminate 31 can be formed integrally together with the lamp base 1. The light guide plate 500 is a transparent sheet, having its bottom side formed as an incident surface located at a place where the illuminant device 3 is to emit, and its upper side opposite to the incident surface formed opaque and attached with a straight or [symbol] -shaped reflection strip 540. A light guide surface (a reflection surface) 510 formed on the inner side of the light guide plate 500 is formed by injection, thermal press or printing to become toothed, or to be spread with a plurality of optical dots to form as an optical-dotted surface 510, and additionally attached with a reflector 530. A light guide surface (an emitting surface) 520 located at the outer side of the light guide plate 500 is formed by injection or thermal press or printing to become toothed, or by making a optical-dotted surface 510, and additionally attached with a diffusion sheet 530.

Matching with the shape of the lamp base 1, the lampshade 6 formed as a square is provided to be covered on the illuminant device 3 and the light guide plate 500, positioned on the lamp base 1.

It is to be noted that, in the first embodiment, the reflector 530 and the diffusion sheet 550 of the light guide plate 500 are used to conduct the light radiated from the LEDs 30 of the illuminant device 3 to enhance the brightness. According to requirement of brightness, an additional prism sheet 560 can be installed outside the diffusion sheet 550 to advance luminous transmittance, or an optical sheet or a colored sheet made of PVC, PET or PMMA can be installed at one side of the emitting surface of the lamp to adjust the shining brightness and the coloration of the illuminant device 3. The fins 11 and the cooling particles 12 formed on the outer and the rear surface of the lamp base 1 are employed to increase a cooling area for the lamp base 1. Through the heat-conductive paste or the heat-conductive tape, heat generated during lighting of the LEDs 30 can be effectively conducted to the lamp base 1 and dispersed to the atmosphere.

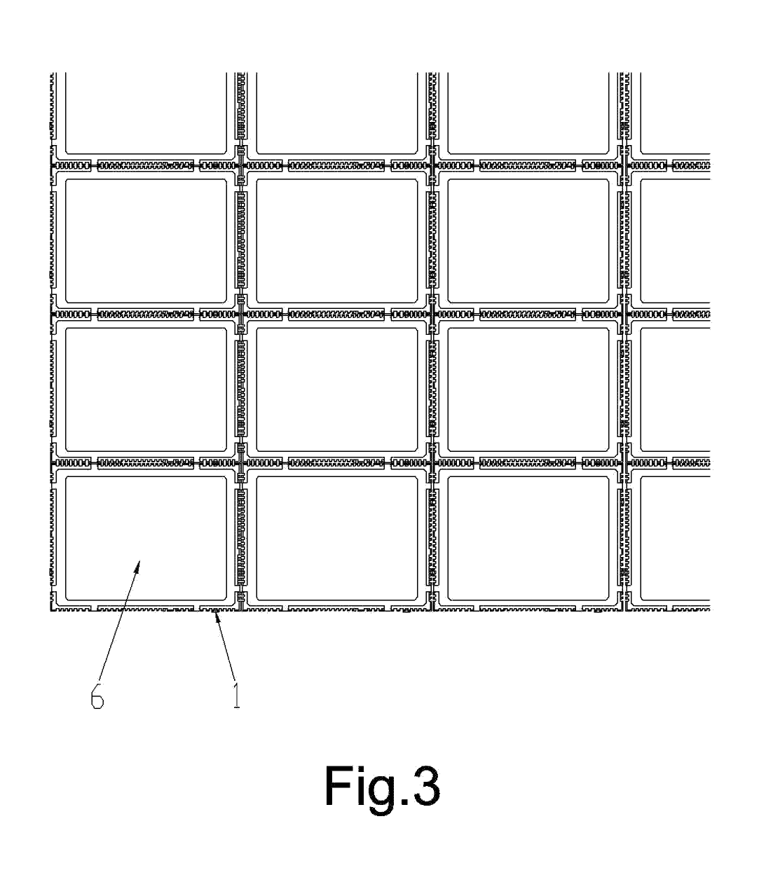

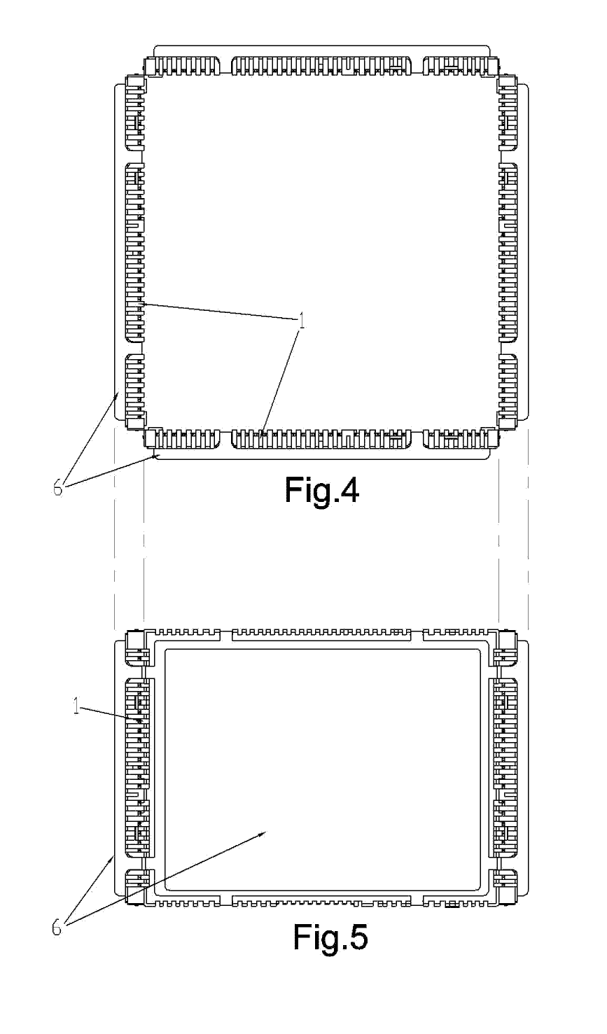

The first embodiment of the present invention can be directly used as a single general light, such as a table lamp or a wall lamp. Or, as shown in FIG. 3, a plurality of the single light can be horizontally arrayed together to widen its emitting surface, usable as a ceiling lamp in a living room or an office or a classroom. Or, as shown in FIGS. 4 and 5, a plurality of the single light can be vertically piled up to keep light beams emitted outward in diverse directions, usable as a walkway lamp or an artistic lamp.

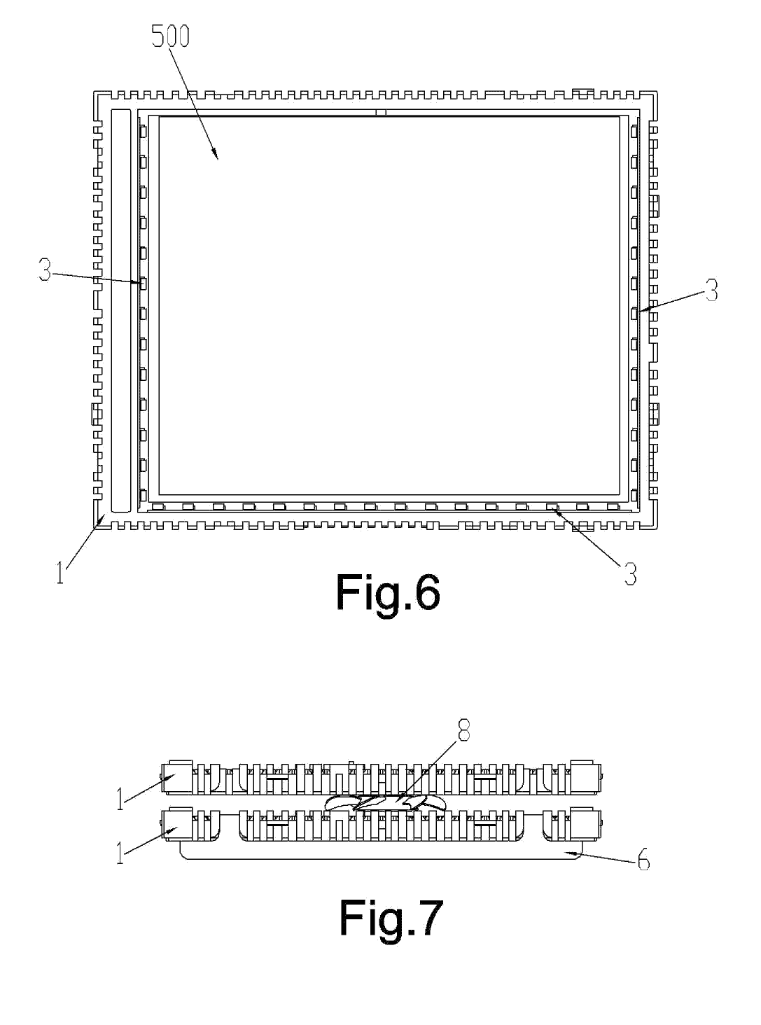

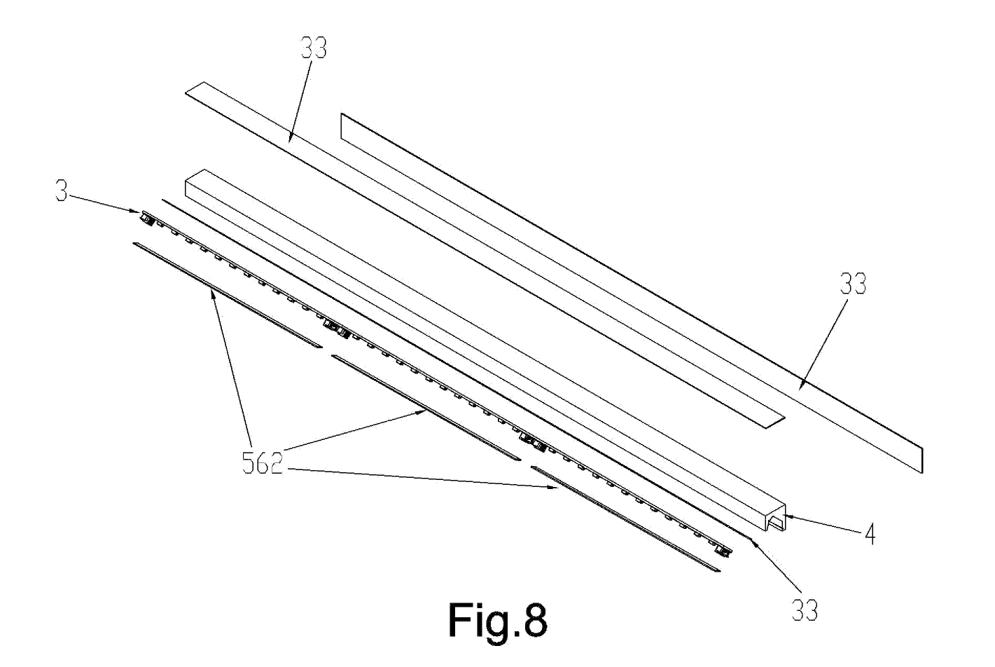

For applying the first embodiment of the present invention with more diversity, the chamber 10 of the lamp base 1 can be installed with more than two illuminant devices 3 to increase the brightness; or more than two illuminant devices 3 composed of the LEDS 30 having different wavelengths are employed to obtain diverse shining colors by means of an adjuster, usable as an artistic decoration or an aquarium lamp, as shown in FIG. 6. Or, as shown in FIG. 7, it can be designed to keep at least two sets of the lamp base 1 loaded together, with a space maintained between every two adjacent lamp base 1 for dispersing heat. A fan or a heat-conductive tube can be installed between the lamp bases 1 to further enforce heat exchange. In experiments, the lamp base 1 with a surface area of 38000 mm² can endure a power consumption of 0˜6 watts and its energy release; but if installed with the fan 8, the lamp base 1 can endure a power consumption up to 12 watts and its energy release; and, if installed with the fan 8 and the heat-conductive tube, the lamp base 1 can endure a power consumption as high as 24 watts and its energy release.

FIG. 8 is an exploded perspective view of a second preferred embodiment of a multi-functional LED lamp in the present invention.

Considering the bulk and the cost, the second preferred embodiment of a multi-functional LED lamp in the present invention is mainly composed of a lamp base 4 and the illuminant device 3. If the brightness has to be adjusted in accordance to practical requirement, the diffusion sheet and the prism sheet are properly assembled. The lamp base 4 is made of a straight aluminum bar. The illuminant device 3 is adhered on the lamp base 1 via coating with a heat-conductive silicon rubber 33. Outside the illuminant device 3 is installed with at least a prism sheet 562. The lamp base 4 is adhered on a piece of glass via a heat-conductive silicon rubber 33, so that the glass can rapidly disperse the heat to allow the LEDs to work with a higher current to advance its brightness without over-heat. Such a lamp can be used in a display window because it can provide enough brightness without raising too much temperature. Therefore, it is able to keep good qualities in the display window without the disadvantage that a great deal of space has to be occupied by the conventional lamp, harming display quality.

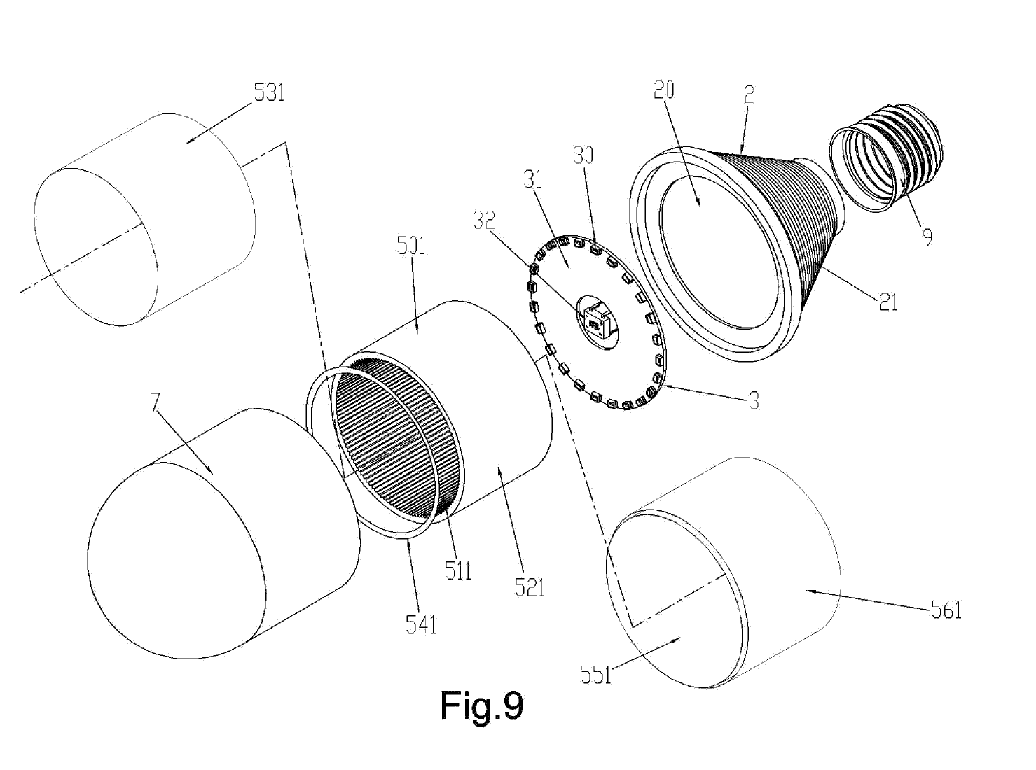

FIG. 9 shows a third preferred embodiment of a multi-functional LED lamp in the present invention, a main figure of this embodiment.

The lamp base 2 is also made of material with an extremely good heat-conductive property via injection or casting or extrusion, generally shaped as a hopper. The lamp base 2 is installed with a general E27 lampholder 9 at its ventage, provided with a multi-layer waved body 21 or fins formed around its outer surface as a cooling member, which can be made integrally together with the lamp base 2, or made into independent components, and then are assembled with the lamp base 2. The multi-layer waved body 21 and the fins can be made integrally together with the lamp base 2, or made into independent components, which are then assembled with the lamp base 2. The lamp base 2 is also provided with a chamber 20 formed inside it. The illuminant device 3 is provided with plural LEDs 30 that are fixed around a circumference of a laminate 31 via tin welding. By means of the heat-conductive medium, the illuminant device 3 is to be properly positioned in the chamber 20 of the lamp base 2. The laminate 31 can be made integrally together with the lamp base 2 and installed with a rectification circuit chip 32 and other passive components at its central portion. A light guide tube 501 is transparent, having its one end used as an incident surface positioned at a place where the illuminant device 3 is to emit, and its other end opposite to the incident surface attached with an annular reflection strip 541. A light guide surface (a reflection surface) 511 located at the inner side of the light guide tube 501 is formed by injection or thermal press or printing to become toothed, or to be an optical dotted surface 511, and additionally attached with a reflector 531 formed cylindrical. A light guide surface (an emitting surface) 521 formed on the outer surface of the light guide tube 501 is formed by injection or thermal press or printing to become toothed, or by making a optical-dot surface to form a flat surface 521, and additionally attached with a diffusion sheet 551 also formed cylindrical. Matching with the shape of the lamp base 2, a lampshade 7 is provided to be covered on the illuminant device 3 and the light guide tube 501, positioned on the lamp base 2.

The general E-series lampholder 9 used as a power connector can be replaced with a 2P1N socket or a direct connecting means. The rectification circuit chip 32 is employed to keep an exterior power (AC) altered into direct current (DC) for the LEDs 30 of the illuminant device 3 to illuminate; and, through the reflector 531 and the diffusion sheet 551 installed respectively inside and outside of the light guide tube 501, the light can be transmitted to upgrade its brightness. Moreover, for diverse requirements of brightness, an additional prism sheet 561 can be installed outside the diffusion sheet 551 to advance luminous transmittance of light, or an optical sheet or a colored sheet made of PVC, PET or PMMA can be installed at one side of the emitting surface of the lamp to adjust the shining brightness and the coloration of the illuminant device 3. The multi-layer waved body 21 or the fins formed on the outer surface of the lamp base 2 are employed to increase cooling area on the lamp base 2, so as to keep the heat generated by the LED bulbs 30 quickly conducted and dispersed.

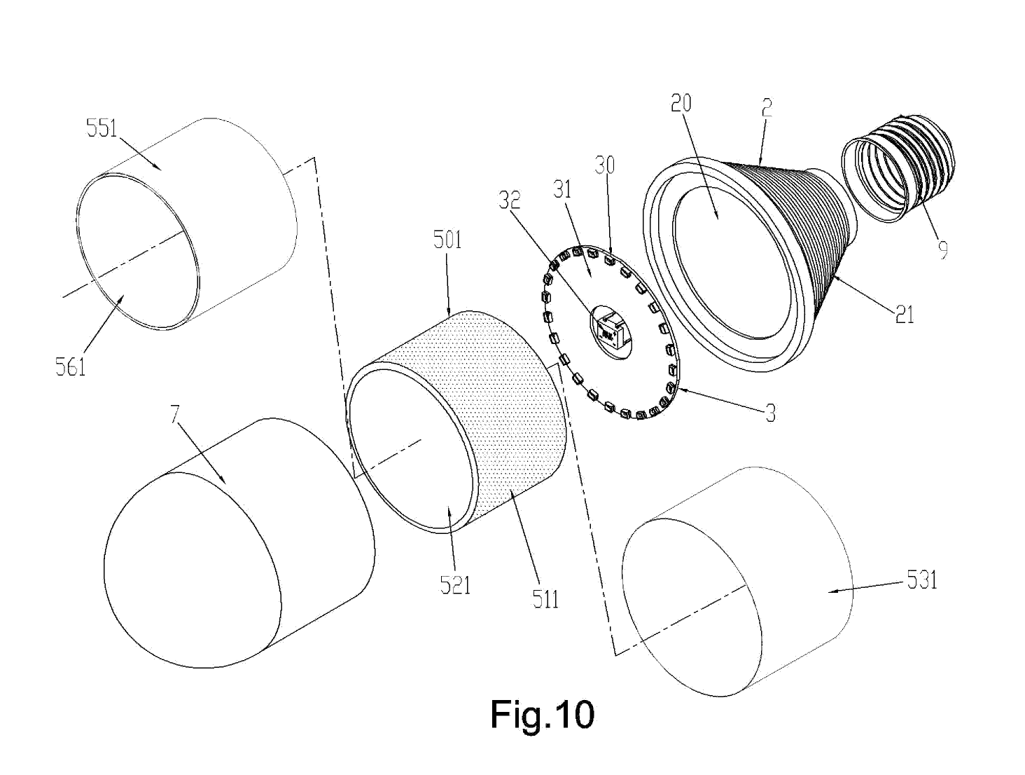

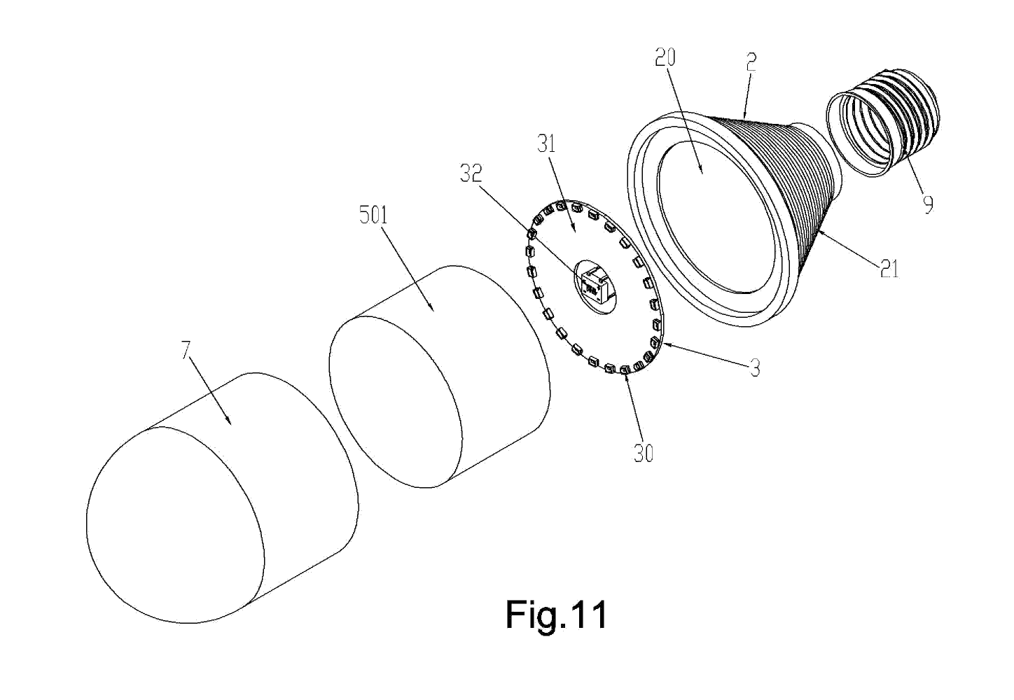

With the dotted surface 511 formed on the inner wall of the light guide tube 501, the flat surface 521 formed on the outer surface of the light guide tube 501, the reflection strip 541 installed at one side of the light guide tube 501, the reflector 531 install inside the light guide tube 501, and the diffusion sheet 551 and the prism sheet 561 installed outside the light guide tube 501, the light of the illuminant device 3 is transmitted to advance its brightness, shining out along the circumference of the light guide tube 501. That is a brief description of installation for FIG. 9. In FIG. 10, the light guide tube 501 has its inner surface replaced with a flat surface (emitting surface) 521 and its outer surface formed as a dotted surface (reflection surface) 511; the annular reflection strip 541 in FIG. 9 is taken off; contrary to FIG. 9, the reflector 531 and the diffusion sheet 551 are installed respectively outside and inside of the light guide tube 501, so that the light of the illuminant device 3 can be focused to intensively illuminate to one side of the light guide tube 501 for the sake of different circumferences and conditions. In FIG. 11, the light guide tube 501 is a solid column, and the reflector 531 and the diffusion sheet 551 are taken off; the light guide tube 501 has its inside formed with bubbles or strips, or its outside adhered with a sticker for decoration.

The reasons why the LED is selected as the illuminant device in the present invention are described below. First, the LED has a high illuminant efficiency and a low energy consumption; that is, under the same brightness, the LED needs a power consumption for only ½˜ 1/10 of the conventional lamp, saving much more energy than the conventional lamp does. Second, the LED has a service life as long as 50000 hours, able to effectively lessen cost if compared with the conventional lamp. Third, the LED is more harmless to the environment as it does not contain any toxic heavy metals, such as lead and mercury, which are contained in the conventional lamp, possible to cause the environment contaminated.

As mentioned in the previous three embodiments, the lamp base, the light guide device and other components in the present invention can be formed in any sizes or shapes, such as a square, a bar or a hopper etc; with the light guide device and the excellent heat-conductive lamp base, the light of the LEDs can be transmitted to advance its brightness and the heat generated by the LED can be rapidly dispersed; with the lampshade, the illuminant device and the light guide device can be decorated and protected. And, combined with the features of the LED, the present invention can really save much energy and advance it brightness. So, it can be diversely applied as a table lamp, a ceiling lamp, a lamp in a car, a braking light, a signal light, a walkway lamp, an advertising light, an artistic lamp or a aquarium light etc.

The invention has the following advantages as can be seen from the foresaid description.

1. With diverse changes of shape and figure, the multi-functional LED lamp in the present invention can take place of the conventional lamp, applied to meet any market requirements that the conventional lamp can satisfy with.

2. With advantages of low energy consumption, long service life and high illuminant efficiency of the LED and the excellent heat-conductive lamp base, the present invention is able to save much energy, lessen cost and advance brightness for a great extent.

3. As the LED does not contain any heavy metal, such as lead and mercury, which are contained in the conventional lamp, possible to contaminate the environment, the present invention is much more ecologically harmless.

While the preferred embodiment of the invention has been described above, it will be recognized and understood that various modifications may be made therein and the appended claims are intended to cover all such modifications that may fall within the spirit and scope of the invention.

1. A multi-functional LED lamp comprising:
a lamp base provided with a cooling member formed on its outer surface and a chamber formed inside it, and,
the lamp base comprises a plurality of fins and cooling particles assembled around the outer surface, and the lamp base is adhered on a piece of glass via a heat-conductive silicon rubber;
an illuminant device provided with plural LEDs welded on a laminate and installed in said chamber of said lamp base, and,
the illuminant device is adhered on the lamp base via coating with a heat-conductive silicon rubber;
a light guide device being transparent and formed as a particular shape to match with a light emitting method of said lamp and having its incident surface located at a particular side where said illuminant device is to emit and an emitting surface formed at its outer surface; and
a lampshade being a cover and covered on an outside of said light guide device and positioned on said lamp base.

2. The multi-functional LED lamp as claimed in claim 1, wherein said cooling member is formed integrally together with said lamp base.

3. The multi-functional LED lamp as claimed in claim 1, wherein said cooling member is made independently into components that are then assembled to said lamp base.

4. The multi-functional LED lamp as claimed in claim 1, wherein said light guide device is provided with a reflector located at its light guide surface.

5. The multi-functional LED lamp as claimed in claim 1, wherein said lamp is provided with a diffusion sheet located at its emitting surface.

6. The multi-functional LED lamp as claimed in claim 1, wherein said lamp is provided with a prism sheet located at its emitting surface.

7. The multi-functional LED lamp as claimed in claim 1, wherein said lamp is provided with a thin optical sheet located at its emitting surface.

8. The multi-functional LED lamp as claimed in claim 1, wherein said lamp is provided with a colored sheet located at its emitting surface.

9. The multi-functional LED lamp as claimed in claim 1, wherein said lamp consists of said lamp base, said illuminant device, a diffusion sheet and a prism sheet.

10. The multi-functional LED lamp as claimed in claim 1, wherein said lamp consists of said lamp base, said illuminant device and a diffusion sheet.

11. The multi-functional LED lamp as claimed in claim 1, wherein said lamp consists of said lamp base, said illuminant device and a prism sheet.

12. The multi-functional LED lamp as claimed in claim 1, wherein said lamp consists of said lamp base, said illuminant device and a thin optical sheet.

13. The multi-functional LED lamp as claimed in claim 1, wherein said lamp consists of said lamp base, said illuminant device and a colored sheet.
